(19) United States
(12) Patent Application Publication
(10) Pub. No.: US 2022/0404005 A1
(43) Pub. Date: Dec. 22, 2022

(54) SET-TOP BOX COLORED LIGHT BAR CAPABLE OF INDEPENDENT INTEGRATED CONTROL

(71) Applicant: Shenzhen Unplug Optoelectronics Co.,Ltd, Shenzhen (CN)

(72) Inventors: Ergang Wen, Shenzhen (CN); Mingjian Liu, Huizhou City (CN)

(21) Appl. No.: 17/648,126

(22) Filed: Jan. 15, 2022

(30) Foreign Application Priority Data
Jun. 16, 2021 (CN) 202121338185.9

(51) Int. Cl. F21V 23/00

(52) U.S. Cl. CPC F21V 23/003; F21V 23/001; F21Y 2115/10

(57) ABSTRACT

The invention is about a set-top box colored light bar capable of independent integrated control, which relates to the technical field of set-top box colored light bars; the set-top box colored light bar comprises a CPU control unit and LEDs; the CPU control unit adopts a DC12V power supply to supply power, an input port of the CPU control unit is connected with a three-path HDMI signal input port, and a signal output port of the CPU control unit is connected with a one-path HDMI signal output port; there are two sets of LEDs, and the two sets of LEDs are connected with pins of the CPU control unit through conducting wires; and according to the set-top box colored light bar capable of independent integrated control, the traditional way of directly controlling the LED by connecting it with a television or other video equipment is changed, the independent CPU control unit is adopted to control the LEDs, video signals are projected on the LEDs through HDMI signal transmission to display, the aim of setting off atmosphere can be achieved, the using scope is wide, use requirements of people can be met, and the effect of simple and useful can be achieved.

### CROSS-REFERENCE TO RELATED APPLICATIONS

This application claims priority to Chinese Patent Application No. 202121338185.9 with a filing date of Jun. 16, 2021. The content of the aforementioned application, including any intervening amendments thereto, are incorporated herein by reference.

### FIELD OF THE INVENTION

The utility model relates to the technical field of set-top box colored light bars, in particular to a set-top box colored light bar capable of independent integrated control.

### BACKGROUND OF THE RELATED ART

With the development of science and technology, people's requirements for material life become higher and higher, especially electronic products can facilitate people's life and improve the quality of entertainment and cultural life. Of course, the prices of electronic products vary according to their different functions and quality. In order to improve the visual experience, colored light bars are installed on the television bodies of some branded televisions, the colored light bars are connected with control units of the television bodies, and the video display effect is improved through HDMI output so as to set off the atmosphere. However, in order to save production costs, colored light bars are not installed on relatively cheap televisions. According to the existing technology, colored light bars independently controlled by independent control units can hardly be used to match video display, the effect of setting off perfect atmosphere cannot be achieved, and the use requirements of users cannot be met. Therefore the set-top box colored light bar capable of independent integrated control is designed and produced so as to solve the above problems.

### SUMMARY OF THE INVENTION

The utility model aims to provide a set-top box colored light bar capable of independent integrated control to solve the problems introduced in the background of the related technology.

In order to solve the above-mentioned technical problems, the utility model provides the following technical scheme: the set-top box colored light bar capable of independent integrated control comprises a CPU control unit and LEDs; the CPU control unit adopts a DC12V power supply to supply power and meet the power supply requirements of the CPU control unit, an input port of the CPU control unit is connected with a three-path HDMI signal input port, and a signal output port of the CPU control unit is connected with a one-path HDMI signal output port; there are two sets of LEDs, and the two sets of LEDs are connected with pins of the CPU control unit through conducting wires; and the three-path HDMI signal input and the one-path HDMI signal output are adopted by the CPU control unit to transmit signals to the television, independent calculation and independent information transmission control of the CPU control unit can be realized, and related images on the television or relative HDMI video equipment are projected onto the LEDs to achieve the effect of heightening atmosphere.

Preferably, the model of the CPU control unit is an 866 CPU control unit, signal loss or delay is not prone to occur to the 866 CPU control unit during signal switching, and the practical integrated level is higher.

Preferably, the pins of the CPU control unit are connected with a K2 switch, which is a mode regulating switch; and by operating the K2 switch manually and through calculation and processing of the CPU control unit, mode regulation can be realized.

Preferably, the pins of the CPU control unit are connected with a K1 switch, which is an HDMI signal source switching switch; and by operating the K1 switch manually and through the calculation and processing of the CPU control unit, HDMI signal source switching regulation can be realized.

Preferably, the pins of the CPU control unit are welded with a USB port, which can be used to externally connect equipment to facilitate the operation of the CPU control unit by using other equipment.

Preferably, the CPU control unit is connected with an intelligent terminal through Bluetooth; and after the CPU control unit is connected with an intelligent terminal through Bluetooth, control and mode switching can be realized through mobile phone applications and other Internet platforms, and more use requirements can be met.

Compared with the existing technology, the utility model has the advantageous effects that:

the set-top box colored light bar capable of independent integrated control changed the traditional way of directly controlling the LED by connecting it with a television or other video equipment, video signals are projected on the LEDs through HDMI signal transmission to display, the aim of setting off atmosphere is achieved, the use scope is wide, the use requirements of people are met, and the effect of simple and useful is achieved.

### BRIEF DESCRIPTION OF THE DRAWINGS

FIG. 1 is the schematic diagram of signal control input and output of the embodiment of the utility model;

FIG. 2 is the circuit diagram of the embodiment of the utility model.

### DETAILED DESCRIPTION OF THE PREFERRED EMBODIMENTS

With reference to the brief drawings of the embodiments of the utility model, the technical schemes of the embodiments of the utility model are described clearly and completely below. Apparently, the described embodiments are only one part of the embodiments of the utility model rather than all of the embodiments. All other embodiments based on the embodiments of the utility model and obtained by those of ordinary skill in this technical field without creative design belong to the protection scope of the utility model.

### Embodiment

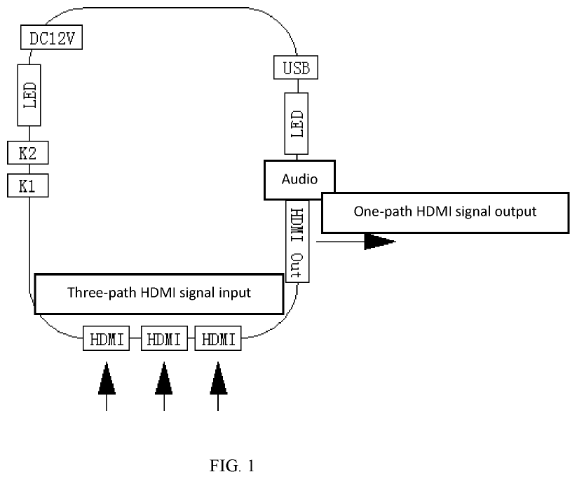

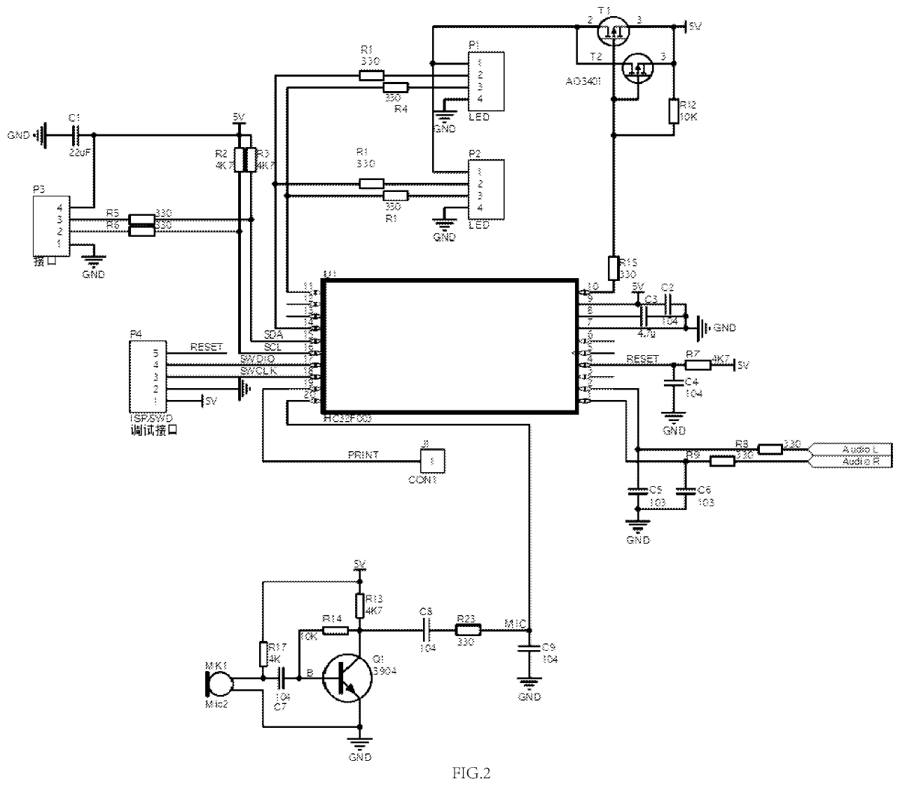

Please refer to FIG. 1 to FIG. 2. The embodiment provides a set-top box colored light bar capable of independent integrated control and comprises a CPU control unit and LEDs, and the CPU control unit adopts a DC12V power supply to supply power and meet the power supply requirements of the CPU control unit.

An input port of the CPU control unit is connected with a three-path HDMI signal input port, and a signal output port of the CPU control unit is connected with a one-path HDMI signal output port; there are two sets of LEDs, and the two sets of LEDs are connected with pins of the CPU control unit through conducting wires; the traditional way of directly controlling the LED by connecting it with a television or other video equipment is changed; and the three-path HDMI signal input and the one-path HDMI signal output are adopted by the CPU control unit to transmit signals to the television, independent calculation and independent information transmission control of the CPU control unit can be realized, and related images on the television or relative HDMI video equipment are projected onto the LEDs to achieve the effect of heightening atmosphere.

The model of the CPU control unit is an 866 CPU control unit, signal loss or delay is not prone to occur to the 866 CPU control unit during signal switching, and the practical integrated level is higher.

The pin 1 of the CPU control unit is connected with a capacitor C6 and then grounded, and the pin 1 is connected with a resister R9 and then connected with the right channel of the audio; the pin 2 is connected with a capacitor C5 and then grounded, and the pin 2 is connected with the left channel of the audio through a resistor R8; the pin 4 is connected with a capacitor C4 and then grounded, and the pin 4 is connected with a 5V power supply through a resistor R7; the pin 7 is grounded, the pin 8 is connected with a capacitor C3 and then grounded, the pin 9 is connected with a 5V power supply and then connected with a capacitor C3 and grounded; the pin 10 of the CPU control unit is connected with one end of a resistor R15, the other end of the resistor R15 is connected with a 5V power supply through a resistor R12 and connected with grid electrodes and drain electrodes of two MOS transistors and pins 1 of LED lights (P1 and P2), and source electrodes of the two MOS transistors are connected with the 5V source; the pin 11 of the CPU control unit is connected with pin 3 of the LED light P1 through a resistor R4 and is connected with pin 3 of the LED light P2 through a resistor R11, the pin 14 of the CPU control unit is connected with pin 2 of the LED light P1 through a resistor R1 and is connected with pin 2 of the LED light P2 through a resistor R10, and pin 4 of the LED light P1 and pin 4 of the LED light P2 are grounded; the pin 15 of the CPU control unit is connected with one end of a resistor R3, the other end of the resistor R3 is grounded through a capacitor C1, and the pin 15 is connected with pin 3 of interface P3 through a resistor R5; the pin 16 of the CPU control unit is connected with one end of a resistor R2, the other end of the resistor R2 is grounded through the capacitor C1, the pin 16 is connected with pin 2 of the interface P3 through a resistor R6, and the other ends of the resistor R2 and the resistor R3 are connected with a 5V power supply; pin 4 of the interface P3 is grounded through the capacitor C1, and pin 1 of the interface P3 is directly grounded; the pin 17 of the CPU control unit is connected with pin 4 of commissioning interface P4; the pin 18 of the CPU control unit is connected with pin 3 of the commissioning interface P4, pin 1 of the commissioning interface P4 is connected with a 5V power supply; the pin 19 of the CPU control unit is connected with a socket con; the pin 20 of the CPU control unit is grounded through a capacitor C9, the pin 20 is connected with a collector electrode of a bipolar junction transistor through a resistor R23 and a capacitor C8, and the collector electrode of the bipolar junction transistor is connected with a 5V power supply through a resistor R13; and the collector electrode of the bipolar junction transistor is connected with a base electrode of the bipolar junction transistor through a resistor R14, the base electrode of the bipolar junction transistor is connected with a sound pick-up through a capacitor C7, the sound pick-up is connected with the 5V power supply through a resistor R17, the grounding end of the sound pick-up is grounded, and the emitting electrode of the bipolar junction transistor is grounded.

According to the embodiment, the model of the bipolar junction transistor is Q1 3904, and the model of the MOS transistor is AO3401.

Pin 5 of the commissioning interface and pin 4 of the CPU control unit are reset switches.

Other pins of the CPU control unit are suspended.

The pins of the CPU control unit are connected with a K2 switch, which is a mode regulating switch; and by operating the K2 switch manually and through calculation and processing of the CPU control unit, mode regulation can be realized.

The pins of the CPU control unit are connected with a K1 switch, which is an HDMI signal source switching switch; and by operating the K1 switch manually and through calculation and processing of the CPU control unit, HDMI signal source switching regulation can be realized.

The pins of the CPU control unit are welded with a USB port, which can be used to externally connect equipment to facilitate the operation of the CPU control unit by using other equipment.

The CPU control unit is connected with an intelligent terminal through Bluetooth; and after the CPU control unit is connected with an intelligent terminal through Bluetooth, control and mode switching can be realized through mobile phone applications and other Internet platforms, and more use requirements can be met.

Although the embodiment of the utility model has been shown and described, for those of ordinary skill in this field, without departing from the principles and spirits of the utility model, various changes, modifications, substitutions and variants of the embodiments can be made; and the scope of the utility model is defined by the attached claims and their equivalents.

We claim:

1. A set-top box colored light bar capable of independent integrated control comprises a CPU control unit and LEDs and is characterized in that the CPU control unit adopts a DC12V power supply to supply power, an input port of the CPU control unit is connected with a three-path HDMI signal input port, and a signal output port of the CPU control unit is connected with a one-path HDMI signal output port;
And there are two sets of LEDs, and the LEDs are connected with pins of the CPU control unit through conducting wires.

2. The set-top box colored light bar capable of independent integrated control according to claim 1, wherein the model of the CPU control unit is an 866 CPU control unit.

3. The set-top box colored light bar capable of independent integrated control according to claim 1, wherein the pins of the CPU control unit are connected with a K2 switch, which is a mode regulating switch.

4. The set-top box colored light bar capable of independent integrated control according to claim 1, wherein the pins of the CPU control unit are connected with a K1 switch, and which is an HDMI signal source switching switch.

5. The set-top box colored light bar capable of independent integrated control according to claim 1, wherein the pins of the CPU control unit are welded with a USB port.

6. The set-top box colored light bar capable of independent integrated control according to claim 1, wherein the CPU control unit is connected with an intelligent terminal through Bluetooth.
